(19) United States
(12) Patent Application Publication
(10) Pub. No.: US 2026/0064090 A1
(43) Pub. Date: Mar. 5, 2026

(54) FREQUENCY RESPONSE FUNCTION IDENTIFICATION SYSTEM

(71) Applicants: KABUSHIKI KAISHA TOYOTA JIDOSHOKKI, Kariya-shi, Aichi (JP); Nagoya Institute of Technology, Nagoya-shi, Aichi (JP)

(72) Inventors: Reina NAKAGAMI, Kariya-shi, Aichi (JP); Yoshihiro MAEDA, Nagoya-shi, Aichi (JP); Wataru HARA, Nagoya-shi, Aichi (JP)

(73) Assignees: KABUSHIKI KAISHA TOYOTA JIDOSHOKKI, Kariya-shi, Aichi (JP); Nagoya Institute of Technology, Nagoya-shi, Aichi (JP)

(21) Appl. No.: 19/106,677

(22) PCT Filed: May 25, 2023
(86) PCT No.: PCT/JP2023/019469

§ 371 Date: Feb. 26, 2025

(30) Foreign Application Priority Data
Aug. 31, 2022 (JP) 2022-138155

(51) Int. Cl. G05B 13/04

(52) U.S. Cl. CPC G05B 13/042

(57) ABSTRACT

A frequency response function identification system 1 includes: an observer 14 that generates an estimated effective torque u^{\hat{ }}ₑ based on a torque command value uᵣ and a motor angular displacement θ_{M}; and an identification unit 15 that identifies a frequency response function based on the estimated effective torque u^{\hat{ }}ₑ and the motor angular displacement θ_{M}. The observer 14 includes: an estimation unit 41 that estimates an estimated motor torque u^{\hat{ }} from the torque command value uᵣ; a static friction model 42 that outputs an estimated static frictional force τ^{\hat{ }}_{f} based on the motor angular displacement θ_{M}; and a calculation unit 43 that calculates the estimated effective torque u^{\hat{ }}ₑ based on the estimated motor torque u^{\hat{ }} and the estimated static frictional force τ^{\hat{ }}_{f}. The identification unit 15 identifies the frequency response function from the estimated effective torque u^{\hat{ }}ₑ and the motor angular displacement θ_{M} using a local frequency modeling method.

### TECHNICAL FIELD

The present disclosure relates to a frequency response function identification system.

### BACKGROUND ART

A system for identifying a frequency response function of a plant is known. For example, Patent Document 1 discloses a servo analyzer that outputs a wideband signal to a system to be measured and performs a discrete Fourier transform on the wideband signal and an output signal from another point of the system to be measured to obtain a transfer function (frequency response function).

### CITATION LIST

### Patent Literature

Patent Document 1: Japanese Patent Application Laid-Open Publication No. 1996-94690

### SUMMARY OF INVENTION

### Technical Problem

In an analysis target, such as a plant, the effective torque driving a linear element of the analysis target may vary due to friction occurring in the analysis target. However, in the servo analyzer disclosed in Patent Document 1, the influence of friction occurring in the analysis target is not considered. Therefore, the identification error of the frequency response function may be increased.

The present disclosure describes a frequency response function identification system capable of improving the identification accuracy of a frequency response function while facilitating the construction of the frequency response function identification system.

### Solution to Problem

A frequency response function identification system according to one aspect of the present disclosure is a system that identifies a frequency response function of an analysis target from a state value obtained by inputting a driving force in accordance with a control value to the analysis target. The frequency response function identification system includes: a generation unit that generates a pre-processing control value in accordance with a difference between a command value and the state value; an adder that generates the control value by adding an excitation value to the pre-processing control value; an observer that generates an estimated effective driving force, which is an estimated value of an effective driving force obtained by excluding a static frictional force that occurs while the analysis target is operating from the driving force, based on the control value and the state value; and an identification unit that identifies the frequency response function based on the estimated effective driving force and the state value. The observer includes: an estimation unit that estimates an estimated driving force, which is an estimated value of the driving force, from the control value; a static friction model defining a relationship between a velocity and the static frictional force, the static friction model that outputs an estimated static frictional force, which is an estimated value of the static frictional force, based on the state value; and a calculation unit that calculates the estimated effective driving force based on the estimated driving force and the estimated static frictional force. The identification unit identifies the frequency response function from the estimated effective driving force and the state value by using a local frequency modeling method.

In the frequency response function identification system, the estimated driving force is estimated from the control value, the estimated static frictional force is output based on the state value, and the estimated effective driving force is calculated based on the estimated driving force and the estimated static frictional force. Then, the frequency response function is identified based on the estimated effective driving force and the state value. Therefore, since the frequency response function is identified by considering the static frictional force, the processing load can be reduced as compared with the case where both the static frictional force and the dynamic frictional force are considered. The static friction model is used to estimate the estimated static frictional force. Since the static friction model is a model for estimating a static frictional force, the static friction model can be constructed more easily than a model for estimating both a dynamic frictional force and a static frictional force. Since the static friction is a friction that occurs while the analysis target is operating (moving), when the frequency response function is identified in the interval in which the static friction occurs, differences in position and velocity arise between the start point and the end point of the interval. Therefore, although a leakage error may occur in the discrete Fourier transform of the state value, the frequency response function and the leakage error can be separated by adding the excitation value to the pre-processing control value and then using the local frequency modeling method. As a result, it is possible to improve the identification accuracy of the frequency response function while facilitating the construction of the frequency response function identification system.

### Advantageous Effects of Invention

According to the present disclosure, it is possible to improve the identification accuracy of the frequency response function while facilitating the construction of the frequency response function identification system.

### BRIEF DESCRIPTION OF DRAWINGS

FIG. 1 is a block diagram showing a configuration of a frequency response function identification system according to an embodiment.

FIG. 2 is a diagram showing an example of the velocity characteristics of a static friction model.

FIG. 3 is a diagram for explaining a time interval in which static friction occurs.

FIG. 4(a) is a diagram showing an example of the gain characteristics of a frequency response function of the plant shown in FIG. 1. FIG. 4(b) is a diagram showing an example of the phase characteristics of the frequency response function of the plant shown in FIG. 1.

FIG. 5(a) is a diagram showing the gain characteristics of frequency response functions of an example and a comparative example. FIG. 5(b) is a diagram showing the phase characteristics of the frequency response functions of the example and the comparative example.

### DESCRIPTION OF EMBODIMENTS

Hereinafter, a frequency response function identification system according to an embodiment will be described in detail with reference to the accompanying drawings. In the description of the drawings, the same or equivalent elements are denoted by the same reference numerals, and redundant description will be omitted.

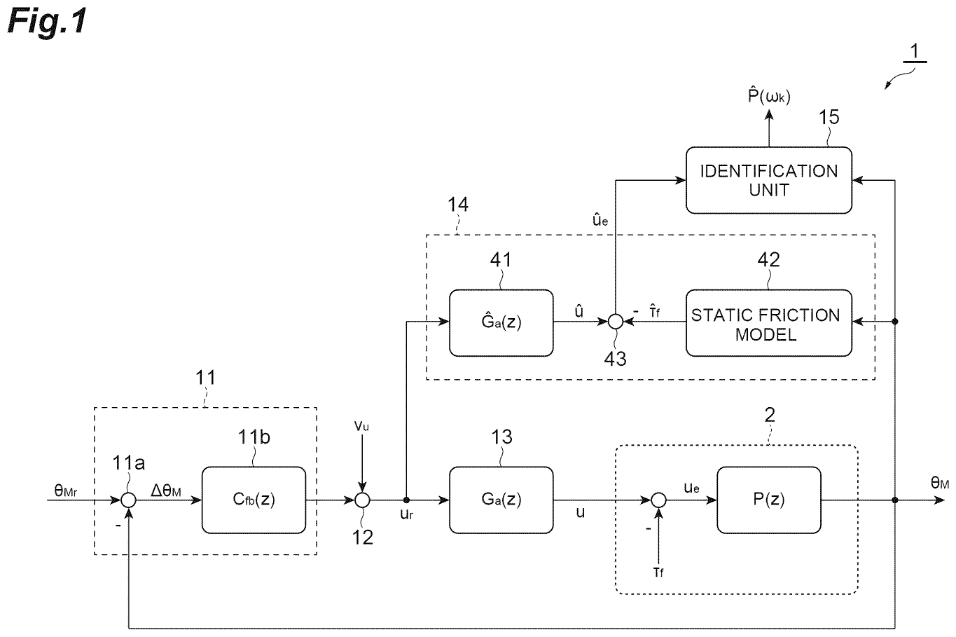

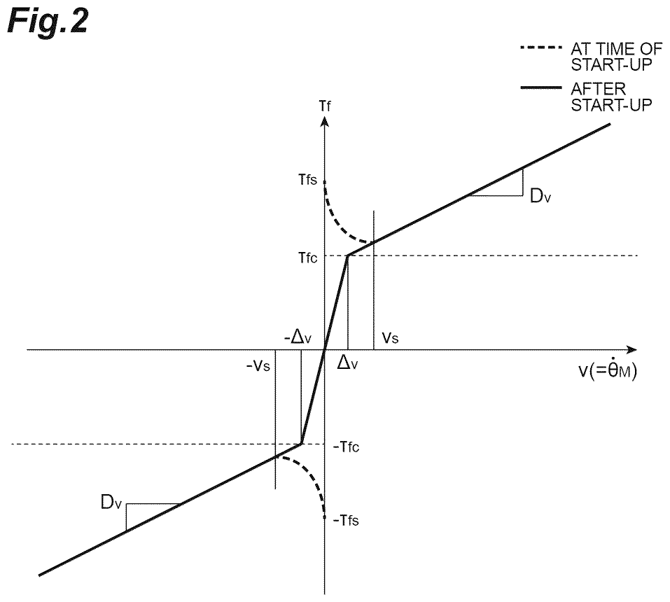

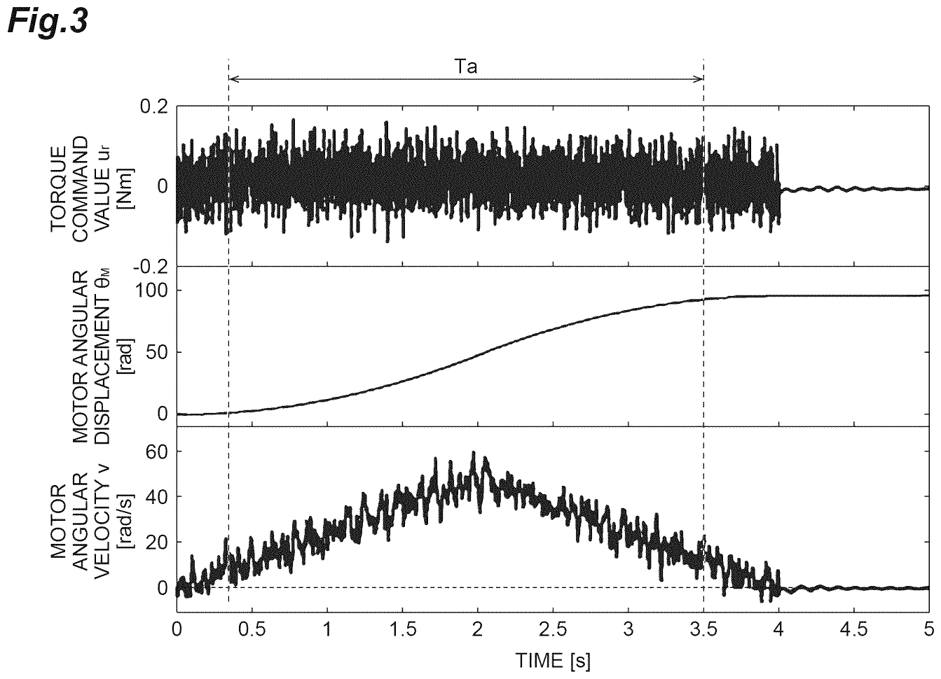

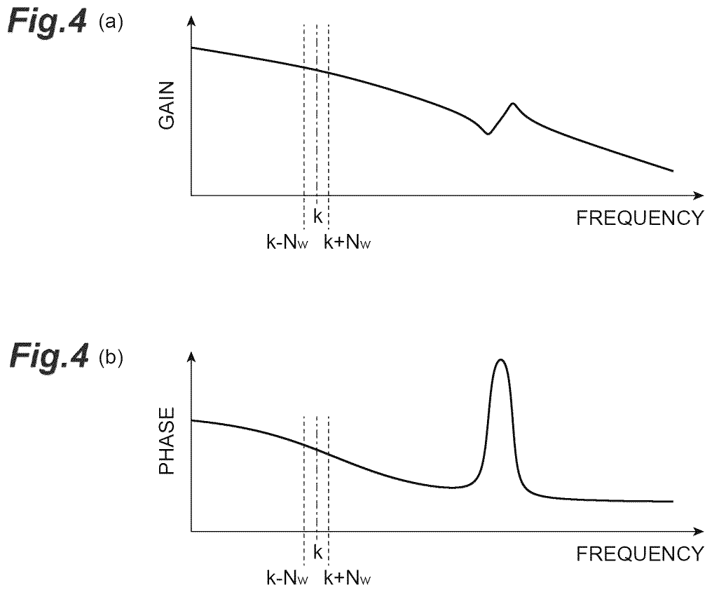

A configuration of a frequency response function identification system according to an embodiment will be described with reference to FIGS. 1 to 4(b). FIG. 1 is a block diagram showing a configuration of a frequency response function identification system according to an embodiment. FIG. 2 is a diagram showing an example of the velocity characteristics of a static friction model. FIG. 3 is a diagram for explaining a time interval in which static friction occurs. FIG. 4(a) is a diagram showing an example of the gain characteristics of a frequency response function of the plant shown in FIG. 1. FIG. 4(b) is a diagram showing an example of the phase characteristics of the frequency response function of the plant shown in FIG. 1.

A frequency response function identification system 1 shown in FIG. 1 is a system that identifies a frequency response function of an analysis target. In the present embodiment, a plant 2 is exemplified as the analysis target. An example of the plant 2 is a servo motor. The frequency response function identification system 1 identifies a frequency response function of the plant 2 from the motor angular displacement θ_{M} (state value). The motor angular displacement θ_{M} is obtained by inputting the motor torque u (driving force) to the plant 2. That is, when the motor torque u is input to the plant 2, the motor angular displacement θ_{M} is output from the plant 2.

The plant 2 may be represented by a non-linear element such as a frictional force and a linear element such as a spring mass. That is, in the frequency response function identification system 1, the linear characteristics (frequency response function P(z)) of the plant 2, which takes the effective torque uₑ (effective driving force) as input and outputs the motor angular displacement θ_{M}, are identified. The effective torque uₑ is obtained by excluding (subtracting) the static frictional force τ_{f} from the motor torque u. The static frictional force tris a frictional force that occurs when the analysis target is in operation. The frequency response function identification system 1 outputs the identified frequency response function (identified frequency response function) to the outside of the frequency response function identification system 1.

The frequency response function identification system 1 may be configured as a computer system including a processor such as a central processing unit (CPU), a memory such as a random access memory (RAM) and a read only memory (ROM), and a communication device such as a network card. The frequency response function identification system 1 includes a generation unit 11, an adder 12, a servo amplifier 13, an observer 14, and an identification unit 15.

The generation unit 11 generates a pre-processing torque command value (pre-processing control value) in accordance with the difference Δθ_{M} between the motor angular displacement command value θ_{Mr} (command value) and the motor angular displacement OM. The motor angular displacement command value θ_{Mr} is a target value of the motor angular displacement θ_{M}. The generation unit 11 receives, for example, the motor angular displacement command value θ_{Mr} from an external control device. The generation unit 11 includes a subtractor 11a and a controller 11b. The subtractor 11a calculates the difference Δθ_{M} by subtracting the motor angular displacement θ_{M} from the motor angular displacement command value θ_{Mr}. The subtractor 11a outputs the difference Δθ_{M} to the controller 11b.

The controller 11b converts the difference Δθ_{M} into the pre-processing torque command value. The controller 11b converts the difference Δθ_{M} into the pre-processing torque command value based on, for example, a predetermined control algorithm. The pre-processing torque command value is a torque command value for matching the motor angular displacement θ_{M} with the motor angular displacement command value θ_{Mr} (setting the difference Δθ_{M} to 0). The controller 11b outputs the pre-processing torque command value to the adder 12.

The adder 12 generates a torque command value uᵣ (control value) by adding an excitation value vᵤ to the pre-processing torque command value. The excitation value vᵤ is the value of the excitation signal. The excitation signal has a frequency spectrum with roughness controlled to a level that allows the identification of the frequency response function to be described later. In other words, the frequency spectrum of the excitation signal has a level of roughness that allows the separation of the frequency response function P(ωₖ) and the leakage error term T(ωₖ) in Equation (2) to be described later. Examples of the excitation signal include random noise or a multisine time signal. To ensure that the torque command value uᵣ and the motor angular displacement θ_{M} do not become excessively larger, a frequency-shaped excitation signal may be used. This frequency shaping may be performed in either the time domain or the frequency domain. The adder 12 outputs the torque command value uᵣ to the servo amplifier 13 and the observer 14.

The servo amplifier 13 outputs the motor torque u in accordance with the torque command value uᵣ to the plant 2. The servo amplifier 13 converts the torque command value uᵣ into the motor torque u based on a predetermined control algorithm. The transfer function Ga(z) represents a control algorithm for converting the torque command value uᵣ into the motor torque u as a transfer function. A servo system is constituted by the generation unit 11, the adder 12, the servo amplifier 13, and the plant 2.

The observer 14 generates an estimated effective torque u^{\hat{ }}ₑ (estimated effective driving force) based on the torque command value uᵣ and the motor angular displacement θ_{M}. The estimated effective torque u^{\hat{ }}ₑ is an estimated value of the effective torque uₑ. For example, in the notation of “u^{\hat{ }}ₑ”, the “^{\hat{ }}” is positioned at the upper right of “u”, but “u^{\hat{ }}ₑ” has the same meaning as the symbol described between the observer 14 and the identification unit 15 in FIG. 1. The same applies to other notations of “^{\hat{ }}”. In this specification, the symbol “^{\hat{ }}” means an estimated value except for the frequency response function, and means an identified value for the frequency response function. The observer 14 includes an estimation unit 41, a static friction model 42, and a calculation unit 43.

The estimation unit 41 estimates an estimated motor torque u^{\hat{ } (estimated driving force) from the torque command value u}ᵣ. The estimated motor torque u^{\hat{ }} is an estimated value of the motor torque u. The estimation unit 41 converts the torque command value uᵣ into the estimated motor torque u^{\hat{ }} using a transfer function G^{\hat{ }}a(z). The transfer function G^{\hat{ }}a(z) is obtained by modeling the servo amplifier 13 by a known method. When the changes in the gain and the phase of the servo amplifier are negligibly small in the frequency band used to identify the frequency response function, the transfer function Ga(z) can be regarded as 1, so that the transfer function G^{\hat{ }}a(z) may be set to 1. The estimation unit 41 outputs the estimated motor torque u^{\hat{ }} to the calculation unit 43.

The static friction model 42 outputs an estimated static frictional force τ^{\hat{ }}_{f} based on the motor angular displacement θ_{M}. The estimated static frictional force τ^{\hat{ }}_{f} is an estimated value of the static frictional force τ_{f}. The static friction model 42 is a model capable of reproducing the velocity characteristics of the static frictional force τ_{f} and defines the relationship between the motor angular velocity v and the static frictional force τ_{f}. As the static friction model 42, a LuGre model and a GMS model which can represent both characteristics of a static frictional force and a dynamic frictional force may be used.

Here, the velocity characteristics of the static friction model 42 will be described with reference to FIG. 2. The horizontal axis of FIG. 2 indicates the motor angular velocity v, and the vertical axis of FIG. 2 indicates the estimated static frictional force τ^{\hat{ }}_{f}.

In the region where the absolute value of the motor angular velocity v is equal to or larger than the minute angular velocity Δv, the estimated static frictional force τ^{\hat{ }}_{f} is expressed as the sum of the linear function term of the motor angular velocity v having the slope of the viscous friction coefficient Dv and the steady-state term by the Coulomb frictional force τ_{fc}, as shown in Equation (1). In the region where the absolute value of the motor angular velocity v is smaller than the minute angular velocity Δv, the estimated static frictional force τ^{\hat{ }}_{f} is expressed as a linear function of the motor angular velocity v having a proportional coefficient larger than the viscous friction coefficient Dv, as shown in Equation (1).

$$\begin{matrix}[ Equation 1 ] & \\ {\hat{τ}}_{f} = \{ \begin{matrix}{D}_{v} v + {τ}_{fc} & ( v \geq Δ v ) \\ {D}_{v} v + \frac{{τ}_{fc}}{Δ v} v & ( - Δ v < v < Δ v ) \\ {D}_{v} v - {τ}_{fc} & ( v \leq - Δ v )\end{matrix} & ( 1 )\end{matrix}$$

The static friction model 42, for example, calculates the motor angular velocity v by differentiating the motor angular displacement θ_{M}, and outputs the estimated static frictional force τ^{\hat{ }}_{f} at the calculated motor angular velocity v.

The calculation unit 43 calculates the estimated effective torque u^{\hat{ }}ₑ based on the estimated motor torque u^{\hat{ }} and the estimated static frictional force τ^{\hat{ }}_{f}. The calculation unit 43 is constituted by, for example, a subtractor. The calculation unit 43 calculates the estimated effective torque u^{\hat{ }}ₑ by subtracting the estimated static frictional force τ^{\hat{ }}_{f} from the estimated motor torque u^{\hat{ }}. The calculation unit 43 outputs the estimated effective torque u^{\hat{ }}ₑ to the identification unit 15.

The identification unit 15 identifies the frequency response function based on the estimated effective torque u^{\hat{ }}ₑ and the motor angular displacement θ_{M}, and outputs the identified frequency response function. Since dynamic friction occurs in a minute displacement region immediately after the sign of the motor angular velocity v is reversed, as shown in FIG. 3, the identification unit 15 determines a time interval Ta in which no dynamic frictional force occurs from the motor angular displacement θ_{M}, and identifies the frequency response function using the estimated effective torque u^{\hat{ }}ₑ obtained in the time interval Ta and the motor angular displacement θ_{M}. The horizontal axis of FIG. 3 indicates time (unit: second). The vertical axis of FIG. 3 indicates the torque command value uᵣ (unit: Nm), the motor angular displacement θ_{M} (unit: rad), and the motor angular velocity v (unit: rad/s) in order from the top. The time interval Ta is a period during which the sign of the motor angular velocity v is not reversed and only a static frictional force occurs. The motor angular displacement θ_{M} in the time interval Ta transits from the start point to the end point of the time interval Ta with a transient response. There is no restriction on the waveform of the transient response of the motor angular displacement θ_{M} as long as the sign of the motor angular velocity v is not reversed. When the time interval during which the sign of the motor angular velocity v is not reversed is sufficiently long, the identification unit 15 may also use the estimated effective torque u^{\hat{ }}ₑ and the motor angular displacement θ_{M} during the time interval Ta′ (for example, the time interval of 0 to 4 s in FIG. 3) in which the sign of the motor angular velocity v is reversed to identify the frequency response function.

When the frequency response function is identified based on the discrete Fourier transform of the estimated effective torque u^{\hat{ }}ₑ and the motor angular displacement θ_{M} in the time interval Ta, an identification error called a leakage error occurs. In order to remove the leakage error, the identification unit 15 identifies a frequency response function from the estimated effective torque u^{\hat{ }}ₑ and the motor angular displacement θ_{M} by using a local frequency modeling method. Examples of local frequency modeling methods include Local Rational Modeling and Local Polynomial Modeling.

Here, the theory of identifying the frequency response function using the local frequency modeling method will be described with reference to FIGS. 4(a) and 4(b). The horizontal axes of FIGS. 4(a) and 4(b) indicate the frequency. The vertical axis of FIG. 4(a) indicates the gain, and the vertical axis of FIG. 4(b) indicates the phase. Here, Local Rational Modeling is used as a local frequency modeling method. In the following description, an input to the linear characteristics of the plant 2 is referred to as an input u, and an output from the linear characteristics of the plant 2 is referred to as an output y. The input u corresponds to the estimated effective torque u^{\hat{ }}ₑ, and the output y corresponds to the motor angular displacement θ_{M}.

The output Y(k) is expressed by Equation (2) using the input U(k), the frequency response function P(ωₖ) of the plant 2, and the leakage error term T(ωₖ). The output Y(k) is the discrete Fourier transform of the output y at the frequency k. The input U(k) is the discrete Fourier transform of the input u at the frequency k. The angular frequency ωₓ is an angular frequency corresponding to the frequency k in the discrete Fourier transform.

$$\begin{matrix}[ Equation 2 ] & \\ Y ( k ) = P ( {ω}_{k} ) U ( k ) + T ( {ω}_{k} ) = \frac{{N}_{P} ( {ω}_{k} )}{D ( {ω}_{k} )} U ( k ) + \frac{{N}_{T} ( {ω}_{k} )}{D ( {ω}_{k} )} & ( 2 )\end{matrix}$$

As shown in Equation (2), the frequency response function P(ωₖ) and the leakage error term T(ωₖ) can be expressed as terms that have a common denominator polynomial D(ωₖ) and different numerator polynomials. As shown in FIGS. 4(a) and 4(b), the frequency response function P(ωₖ) and the leakage error term T(ωₖ) are assumed to be smooth within a local frequency window from frequency (k−N_{w}) to frequency (k+N_{w}). The window size N_{w} is a positive integer value. Equation (3) is obtained by setting each of the frequency response function P(ωₖ) and the leakage error term T(ωₖ) as a rational function model with respect to the frequency r within the local frequency window having the window size N_{w}. θ_{Pq}(k), θ_{Tq}(k), and θ_{Dq}(k) are coefficient parameters. q is an integer value from 0 to R. R is a polynomial degree.

$$\begin{matrix}[ Equation 3 ] & \\ {\tilde{Y}}_{k + r} := {\tilde{P}}_{k + r} ( r , {θ}_{Pq} ( k ) , {θ}_{Dq} ( k ) ) U ( k + r ) + {\tilde{T}}_{k + r} ( r , {θ}_{Tq} ( k ) , {θ}_{Dq} ( k ) ) & ( 3 )\end{matrix}$$

A rational function model P^{˜}ₖ₊ᵣ(r, θ_{Pq}(k), θ_{Dq}(k)) of the frequency response function P(ωₖ) is expressed by Equation (4). For example, in the notation “P^{˜}ₖ₊ᵣ”, the “^{˜}” is positioned at the upper right of “P”, but “P^{˜}ₖ₊ᵣ(r, θ_{Pq}(k), θ_{Dq}(k))” has the same meaning as the left side of Equation (4). The same applies to other notations of “^{˜}”. In this specification, the symbol “^{˜}” means a model.

$$\begin{matrix}[ Equation 4 ] & \\ {\tilde{P}}_{k + r} ( r , {θ}_{Pq} ( k ) , {θ}_{Dq} ( k ) ) = \frac{{\tilde{N}}_{Pk + r} ( r , {θ}_{Pq} ( k ) )}{{\tilde{D}}_{k + r} ( r , {θ}_{Dq} ( k ) )} = \frac{{\sum }_{q = 0}^{R} {θ}_{Pq} ( k ) {r}^{q}}{1 + {\sum }_{q = 1}^{R} {θ}_{Dq} ( k ) {r}^{q}} & ( 4 )\end{matrix}$$

A rational function model T^{˜}ₖ₊ᵣ(r, θ_{Tq}(k), θ_{Dq}(k)) of the leakage error term T(ωₖ) is expressed by Equation (5). Since the frequency response function P(ωₖ) and the leakage error term T(ωₖ) have a common denominator polynomial D(ωₖ), both the rational function model P^{˜}ₖ₊ᵣ(r, θ_{Pq}(k), θ_{Dq}(k)) and the rational function model T^{˜}ₖ₊ᵣ(r, θ_{Tq}(k), θ_{Dq}(k)) have a common denominator polynomial and have different numerator polynomials.

$$\begin{matrix}[ Equation 5 ] & \\ {\tilde{T}}_{k + r} ( r , {θ}_{Tq} ( k ) , {θ}_{Dq} ( k ) ) = \frac{{\tilde{N}}_{Tk + r} ( r , {θ}_{Tq} ( k ) )}{{\tilde{D}}_{k + r} ( r , {θ}_{Dq} ( k ) )} = \frac{{\sum }_{q = 0}^{R} {θ}_{Tq} ( k ) {r}^{q}}{1 + {\sum }_{q = 1}^{R} {θ}_{Dq} ( k ) {r}^{q}} & ( 5 )\end{matrix}$$

Subsequently, the identification unit 15 determines a solution θ^{\hat{ }}(k) for the parameter θ(k) that minimizes Equation (6) by the least squares method so that Y^{˜}ₖ₊ᵣ matches with Y(k+r) within the local frequency window. The parameter θ(k) is expressed by Equation (7). It should be noted that a necessary condition for solving the above optimization problem is 2N_{w}+1≥3R+2.

$$\begin{matrix}[ Equation 6 ] & \\ \begin{matrix}\hat{θ} ( k ) = {arg min}_{θ ( k )} {\sum }_{r = - {N}_{w}}^{{N}_{w}} {\vert {\tilde{D}}_{k + r} ( r , {θ}_{Dq} ( k ) ) ( Y ( k + r ) - {\tilde{Y}}_{k + r} ( r , {θ}_{Pq} , {θ}_{Tq} , {θ}_{Dq} ) ) \vert}^{2} \\ = {arg min}_{θ ( k )} {\sum }_{r = - {N}_{w}}^{{N}_{w}} {\vert Y ( k + r ) {\tilde{D}}_{k + r} ( r , {θ}_{Dq} ( k ) ) - {\tilde{N}}_{Pk + r} ( r , {θ}_{Pq} ( k ) ) U ( k + r ) - {\hat{N}}_{Tk + r} ( r , {θ}_{Tq} ( k ) ) \vert}^{2}\end{matrix} & ( 6 )\end{matrix}$$

$$\begin{matrix}[ Equation 7 ] & \\ θ ( k ) = [ {θ}_{P 0} ( k ) {θ}_{P 1} ( k ) … {θ}_{PR} ( k ) {θ}_{T 0} ( k ) {θ}_{T 1} ( k ) … {θ}_{TR} ( k ) {θ}_{D 1} ( k ) … {θ}_{DR} ( k ) ] & ( 7 )\end{matrix}$$

The identification unit 15 determines the solution θ^{\hat{ }}(k) of the parameter θ(k) that minimizes Equation (6) at all frequencies k={0, 1, . . . , N−1} (N is the data length of the discrete Fourier transform). Then, the identification unit 15 obtains an identification frequency response function P^{\hat{ }}(ωₖ) at each frequency by using Equation (8).

$$\begin{matrix}[ Equation 8 ] & \\ \hat{P} ( {ω}_{k} ) := {\tilde{P}}_{k + 0} ( r , {θ}_{Pq} ( k ) , {θ}_{Dq} ( k ) ) = \frac{{\tilde{N}}_{Pk + 0} ( r , {θ}_{Pq} ( k ) )}{{\tilde{D}}_{k + 0} ( r , {θ}_{Dq} ( k ) )} = {\hat{θ}}_{P 0} ( k ) & ( 8 )\end{matrix}$$

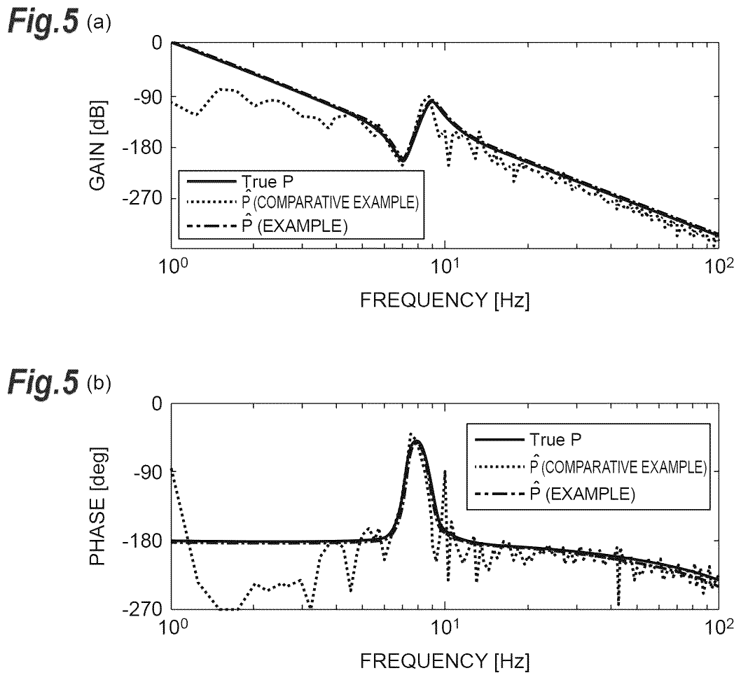

Next, the operation and effect of the frequency response function identification system 1 will be described with reference to FIGS. 5(a) and 5(b). FIG. 5(a) is a diagram showing the gain characteristics of frequency response functions of an example and a comparative example. FIG. 5(b) is a diagram showing the phase characteristics of the frequency response functions of the example and the comparative example. The horizontal axes of FIGS. 5(a) and 5(b) indicate the frequency (unit: Hz). The vertical axis of FIG. 5(a) indicates the gain (unit: dB), and the vertical axis of FIG. 5(b) indicates the phase (unit: deg).

The frequency response function of the example is a frequency response function identified by the frequency response function identification system 1 using the estimated effective torque u^{\hat{ }}ₑ and the motor angular displacement θ_{M} when the period of 0.25 to 3.5 s in FIG. 3 is defined as the time interval Ta. The frequency response function of the comparative example is a frequency response function identified when the sign of the motor angular velocity v is frequently reversed in the time interval Ta of 0.25 to 3.5 s, which is the same as in the example, with the motor angular displacement command value θ_{Mr} (command value) of FIG. 1 set to zero. As shown in FIGS. 5(a) and 5(b), the frequency response function of the comparative example fails to reproduce the frequency response function of the analysis target at a frequency of 10 Hz or less. On the other hand, the frequency response function of the example completely coincides with the frequency response function of the analysis target.

In the frequency response function identification system 1 described above, the estimated motor torque u^{\hat{ }} is estimated from the torque command value uᵣ, the estimated static frictional force τ^{\hat{ }}_{f} is output based on the motor angular displacement OM, and the estimated effective torque u^{\hat{ }}ₑ is calculated based on the estimated motor torque u^{\hat{ }} and the estimated static frictional force τ^{\hat{ }}_{f}. Then, the frequency response function is identified based on the estimated effective torque u^{\hat{ }}ₑ and the motor angular displacement θ_{M}. Therefore, since the frequency response function is identified by considering the static frictional force, the processing load can be reduced as compared with the case where both the static frictional force and the dynamic frictional force are considered.

The static friction model 42 is used to calculate the estimated static frictional force τ^{\hat{ }}_{f}. Since the static friction model 42 is a model for estimating the static frictional force τ_{f}, the static friction model 42 can be constructed more easily than a model for estimating both the dynamic frictional force and the static frictional force. Since the static friction is the friction that occurs during the operation of the plant 2, when the frequency response function is identified in the time interval Ta in which the static friction occurs, differences in position and velocity arise between the start point and the end point of the interval. Therefore, although a leakage error may occur in the frequency response function identified based on the discrete Fourier transform, the frequency response function and the leakage error can be separated by using the local frequency modeling method for the torque command value uᵣ obtained by adding the excitation value vᵤ to the pre-processing torque command value. As a result, it is possible to improve the identification accuracy of the frequency response function while facilitating the construction of the frequency response function identification system 1.

In the plant 2 in which a large frictional force occurs, it is also possible to identify the frequency response function while suppressing the influence of the frictional force by increasing the excitation value vᵤ. However, since increasing the excitation value vᵤ may cause the plant 2 to vibrate greatly, such a technique may not be applied. On the other hand, in the frequency response function identification system 1, since the estimated effective torque u^{\hat{ }}ₑ obtained by subtracting the estimated static frictional force τ^{\hat{ }}_{f} from the estimated motor torque u^{\hat{ }} is used, the influence of the frictional force on the identification of the frequency response function can be reduced, and the frequency response function can be identified with a small excitation value vᵤ.

In the frequency response function identification system 1, since the frequency response function is identified with high accuracy, it is possible to design a controller for realizing high-performance servo control. The frequency response function can be identified even when the servo system is in operation and performing positioning operations. Therefore, the controller can be adjusted at a high frequency even during the operation of the servo system, and the abnormality of the servo system can be diagnosed during the operation.

While an embodiment of the present disclosure has been described in detail, the frequency response function identification system according to the present disclosure is not limited to the above embodiment.

As long as the static friction model 42 can reproduce the velocity characteristics of the static frictional force τ_{f} in a partial region where the absolute value of the motor angular velocity v is equal to or larger than the minute angular velocity Δv, the static friction model 42 does not need to reproduce the velocity characteristics in a region where the absolute value of the motor angular velocity v is smaller than the minute angular velocity Δv, for example. Similarly, the velocity characteristics does not need to be reproduced in a region where the absolute value of the motor angular velocity v is larger than the operating angular velocity at the time of identifying the frequency response function.

The analysis target (plant 2) is not limited to the servo motor. When a servo motor is not used, an operation device for converting a command value into a drive value is used instead of the servo amplifier 13. The analysis target may be any device that outputs a state value when a driving force is input. The state value may be any of position, velocity, and acceleration. When the state value is a position, the static friction model 42 may convert the state value into a velocity by differentiating the state value, or may estimate the velocity by an observer. Similarly, when the state value is an acceleration, the static friction model 42 may convert the state value into a velocity by integrating the state value, or may estimate the velocity by an observer.

### REFERENCE SIGNS LIST

1 . . . frequency response function identification system, 2 . . . plant (analysis target), 11 . . . generation unit, 11a . . . subtractor, 11b . . . controller, 12 . . . adder, 13 . . . servo amplifier, 14 . . . observer, 15 . . . identification unit, 41 . . . estimation unit, 42 . . . static friction model, 43 . . . calculation unit.

1. A frequency response function identification system that identifies a frequency response function of an analysis target from a state value obtained by inputting a driving force in accordance with a control value to the analysis target, the frequency response function identification system comprising:
a generation unit configured to generate a pre-processing control value in accordance with a difference between a command value and the state value;
an adder configured to generate the control value by adding an excitation value to the pre-processing control value;
an observer configured to generate an estimated effective driving force, which is an estimated value of an effective driving force obtained by excluding a static frictional force that occurs while the analysis target is operating from the driving force, based on the control value and the state value; and
an identification unit configured to identify the frequency response function based on the estimated effective driving force and the state value,
wherein the observer comprises:
an estimation unit configured to estimate an estimated driving force, which is an estimated value of the driving force, from the control value;
a static friction model defining a relationship between a velocity and the static frictional force, the static friction model configured to output an estimated static frictional force, which is an estimated value of the static frictional force, based on the state value; and
a calculation unit configured to calculate the estimated effective driving force based on the estimated driving force and the estimated static frictional force, and
wherein the identification unit identifies the frequency response function from the estimated effective driving force and the state value by using a local frequency modeling method.
